(19) United States
(12) Patent Application Publication
(10) Pub. No.: US 2017/0070798 A1
(43) Pub. Date: Mar. 9, 2017

(54) Spy Block

(71) Applicant: Russell b Arnold, Tallahassee, FL (US)

(72) Inventor: Russell b Arnold, Tallahassee, FL (US)

(21) Appl. No.: 14/752,982

(22) Filed: Sep. 9, 2015

(51) Int. Cl. H04R 1/08; A63B 71/02

(52) U.S. Cl. CPC H04R 1/083; A63B 71/02

(57) ABSTRACT

The Spy Block invention is an innovative product designed to protect an important strategic advantage during football games. The unique design will help to insure that all conversations held by football coaches over headsets are kept confidential from opposing sideline and potential spies in the stadium crowd. Spy Block will be marketed as a sporting goods accessory. The unique oval concave shaped, lightweight plastic—snap on accessory will be used to cover microphone headsets to guarantee privacy when calling plays. The product will be made out of lightweight plastic, height 4-6 inches and length 6-8 inches, basic color-black or color of headset. The unique plastic design will be extremely lightweight and unobtrusive to regular headset usage. The unique design will be easy to implement on virtually any headset with a microphone and will be competitively priced, adding to its appeal. It is anticipated that adding logos of teams to the Spy Block product will add personalization to this sporting goods accessory.

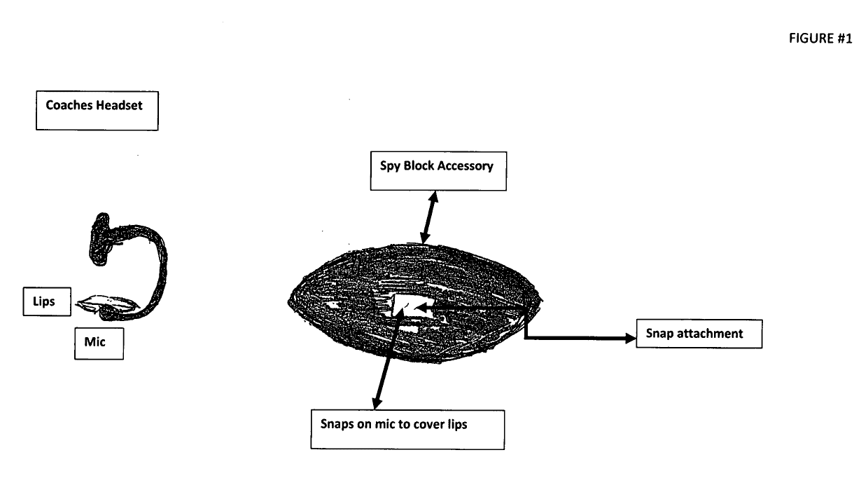

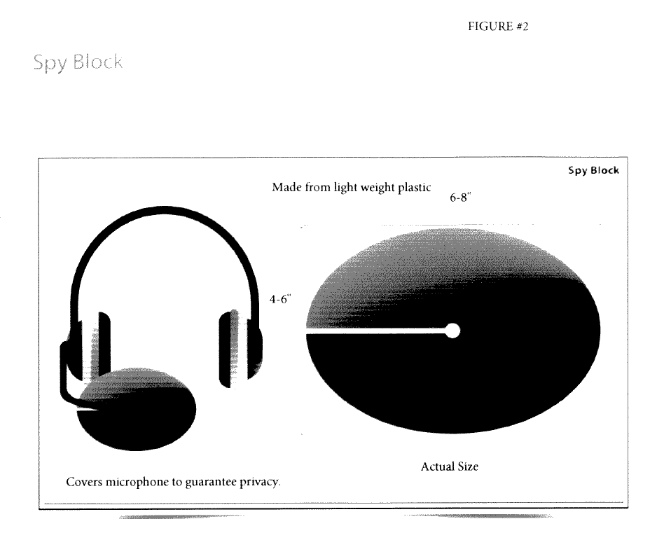

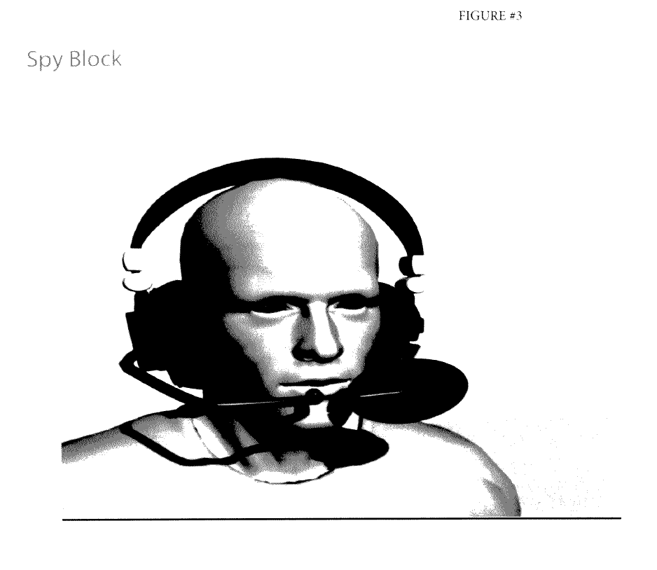

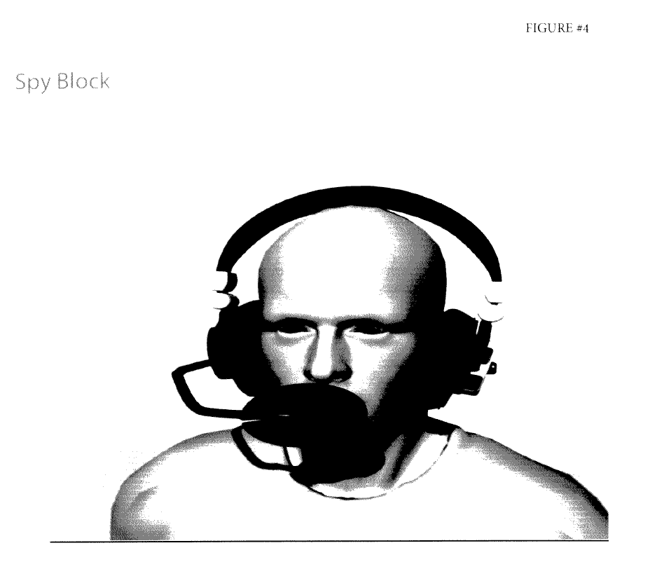

### BACKGROUND OF THE INVENTION

Dec. 1, 2013, while watching football on television, Mr. Russell B. Arnold, Sr., came up with the idea to create a new product to protect an important strategic advantage during football games. He realized that coaching staffs were using writing pads or some type of portfolio to cover their headsets when calling plays, to prevent the opposing team from reading their lips or spying on them. After the game he made a draft drawing of a product or accessory that would block the opponent's ability to read the lips or “spy” on the opposing team's coaching staff as plays are communicated between staff and players. Hence the name “Spy Block,” an accessory to cover the mouth and microphone of the headphone headset. With the idea fresh on his mind and the draft sketch in hand, he began looking for a way to patent his idea. While watching TV he saw and Ad from a Miami, Fla.-based product management company “Innovation Direct.” He contacted the company and asked for assistance in getting his product idea patented, and possibly manufactured, marketed and distributed. A product management services agreement was signed for Innovation Direct to provide Product/Patent Management Services for a two-year period. On Jul. 1, 2015, a Provisional Patent Application No.: 62/019,772 was filed with the USPTO.

### BRIEF SUMMARY OF THE INVENTION

Spy Block is an innovative product designed to protect an important strategic advantage during football games. The unique design helps insure that all conversations held by coaches over headsets are kept confidential from opposing sideline and potential spies in the stadium crowd. The Spy Block insures fair play during the course of a football game. The product provides peace of mind each team and allows them to call plays faster and with more confidence. Additionally, to the Spy Block will be extremely lightweight and unobtrusive to regular headset usage. Furthermore, it will be easy to implement on virtually any headset with a microphone and will be competitively priced, adding to its appeal.

### BRIEF DESCRIPTION OF THE FOUR (4) VIEWS OF THE DRAWING:

1. Original basic drawing of the Spy Block accessory with inventor's notes on how the product would look and how to attach it to the headset.

2. Computer generated one dimensional front view drawing of the Spy Block product measurements, and view of how the product covers microphone to guarantee privacy.

3. Front view of head shot with headset—before attaching Spy Block product.

4. Front view of head shot with headset and Spy Block product attached demonstrating how the product prevents opponents from reading lips

### DETAILED DESCRIPTION OF THE INVENTION:

Sporting Goods accessory
Oval concave shape—lightweight plastic—snaps on accessory to cover microphone to guarantee privacy
Size: height 4-6″ length 6-8″
Color—black or color of headset

Patent subject matter eligibility: Manufacture—an article produced from raw or prepared materials by giving to these materials new forms, qualities, properties, or combinations, whether by hand labor or by machinery.

1. Spy Block's unique plastic design will be extremely lightweight and unobtrusive to regular headset usage.

2. (canceled)

3. Spy Block unique design will help insure that all conversations held by coaches over headsets are kept confidential from opposing sideline and potential spies in the stadium crowd.

4. (canceled)

5. The Spy Block product will provide peace of mind for each team and allows them to call plays faster and with more confidence.

6. (canceled)
